(19) United States
(12) Patent Application Publication
(10) Pub. No.: US 2006/0075751 A1
(43) Pub. Date: Apr. 13, 2006

(54) Hydraulic system for providing an auxiliary force for a motor vehicle device

(75) Inventors: Joerg Bender, Radolfzell (DE); Hans-Ullrich Jacob, Stockach (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Electronics & Components GmbH & Co. KG

(21) Appl. No.: 11/243,638

(22) Filed: Oct. 5, 2005

(30) Foreign Application Priority Data
Oct. 13, 2004 (DE) 10 2004 049 883.0

(51) Int. Cl. F16D 31/02

(52) U.S. Cl. 60/456

(57) ABSTRACT

A hydraulic system for providing an auxiliary force for a motor vehicle device has a fluid circulation system. The fluid circulation system includes a pump (14), an electromotor (16) and a reservoir (12). The pump (14) delivers fluid from the reservoir (12). The electromotor (16) drives the pump (14). The electromotor (16) is provided with a cooling jacket (28), which defines a cooling chamber (30). Fluid of the fluid circulation system flows through the cooling chamber (30).

### TECHNICAL FIELD

The present invention relates to a hydraulic system for providing an auxiliary force for a motor vehicle device.

### BACKGROUND OF THE INVENTION

A hydraulic system of this type usually comprises a fluid circulation system including a pump, an electromotor and a reservoir, the pump delivering fluid from the reservoir and the electromotor driving the pump. Such a hydraulic system can be used for hydraulic steering assistance in power steering systems. Due to the dynamic demands regarding the response time of the steering systems, on the one hand, and the demand for low energy consumption to achieve high efficiency, on the other hand, internal-rotor motors are increasingly used for hydraulic systems of this type. The use of such motors having an internal rotor and an external stator makes it possible to meet these demands because they offer significant advantages in comparison to known external-rotor motors due to the smaller masses that need to be accelerated.

Internal-rotor motors are generally designed so that under extreme stress they operate at their power limit. Such conditions correspond to special examination and test conditions under which the prescribed steering cycles occur over a defined period of time. In everyday driving, it is then safe to assume a sufficient power reserve. To reach the required power parameters, internal-rotor motors have been developed in which the electrical parts are exposed to the working medium (fluid) of the hydraulic oil circulation so that sufficient cooling of the motor components is achieved.

One example of a hydraulic system of this type is shown in German Utility Model DE 203 02 534 U1. Of course, in a system of this type, the rotating rotor must operate against the viscosity of the oil, thus creating turbulence in the medium resulting in power loss. Furthermore, the loss in power especially increases when the motor/pump aggregate is designed to operate in the cold range (e.g., −40° C.) where the oil has a correspondingly high viscosity. To compensate for these unavoidable power losses, the motor must be designed stronger so that it can produce the necessary power.

It is an object of the present invention to provide a hydraulic system in which an efficient cooling of the electromotor is ensured without excessive power losses.

### BRIEF SUMMARY OF THE INVENTION

According to the present invention, a hydraulic system for providing an auxiliary force for a motor vehicle device comprises a fluid circulation system; the fluid circulation system includes a pump, an electromotor and a reservoir; the pump delivers fluid from the reservoir; the electromotor drives the pump; the fluid circulation system further includes a cooling jacket for the electromotor; the cooling jacket defines a cooling chamber; fluid of the fluid circulation system flows through the cooling chamber. The present invention makes a special use of the—in other technical fields—known and proven principle of cooling a motor using a cooling jacket. According to the invention, the cooling jacket is supplied not with a separate coolant but rather with the fluid of the fluid circulation system itself, i.e., the cooling chamber, defined by the cooling jacket, is directly integrated in the fluid circulation system. Therefore, it is not necessary to provide a separate cooling system for the electromotor, and the expense for additional lines and connections in the fluid circulation system is minimal. The indirect cooling of the electromotor using the cooling jacket has the advantage that the electrical parts of the motor do not have fluid flowing around them, so that it is possible to dispense with expensive external seals. In addition, the fluid is not stirred up, and so-called “initial breakaway torques” due to high viscosity are eliminated. The electromotor can therefore be designed to operate at a lower power level.

The cooling chamber is preferably arranged in a return line of the fluid circulation system. An arrangement of this type is advantageous because the fluid in the return line is already somewhat cooler and has almost no pressure.

However, it is in principle also possible to arrange the cooling chamber in a pressure line of the fluid circulation system, e.g., by dividing the pressure-side volume flow into an operating flow and a cooling flow. In this case, however, the power output of the hydraulic system is correspondingly reduced, and accordingly it is necessary to provide a pressure-tight design of the cooling chamber.

### BRIEF DESCRIPTION OF THE DRAWINGS

FIG. 1 shows a schematic representation of a hydraulic system according to the present invention; and

FIG. 2 shows a sectional view of an electromotor for a hydraulic system according to the present invention.

### DETAILED DESCRIPTION OF THE PREFERRED EMBODIMENTS

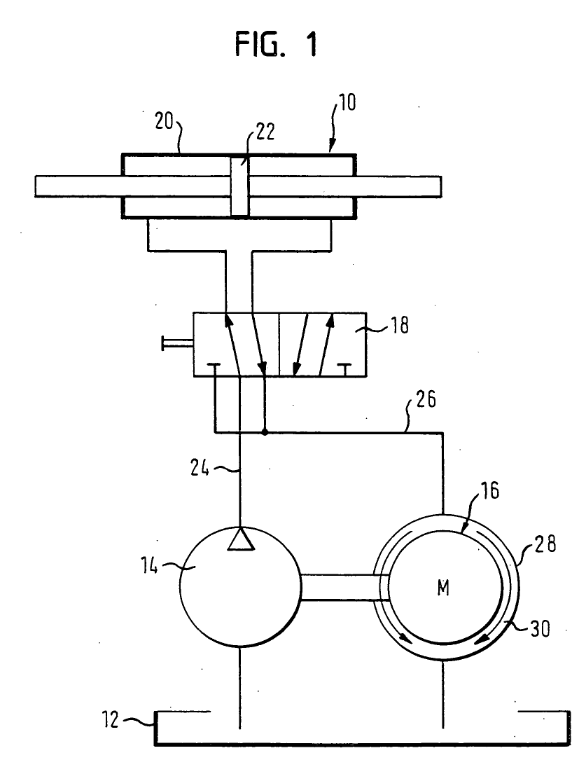

FIG. 1 shows a hydraulic system according to the present invention in the example of a motor-vehicle steering assistance device 10 depicted in simplified form. The hydraulic system includes a fluid reservoir 12, a pump 14, which is driven by an electromotor 16, and a control valve 18. Depending on the position of control valve 18, a piston 22 that is movably supported in a cylinder 20 of steering assistance device 10 can be moved to the right or to the left, so as to provide steering force assistance in the desired direction. The fluid that is conveyed by pump 14 from reservoir 12 is supplied to control valve 18 via a pressure line 24. The fluid flowing back from steering assistance device 10 is delivered back to reservoir 12 by a return line 26.

Electromotor 16 has a cooling jacket 28, which surrounds the hot-running motor parts. Cooling jacket 28 defines a cooling chamber 30, through which fluid of return line 26 flows before it is delivered back into reservoir 12.

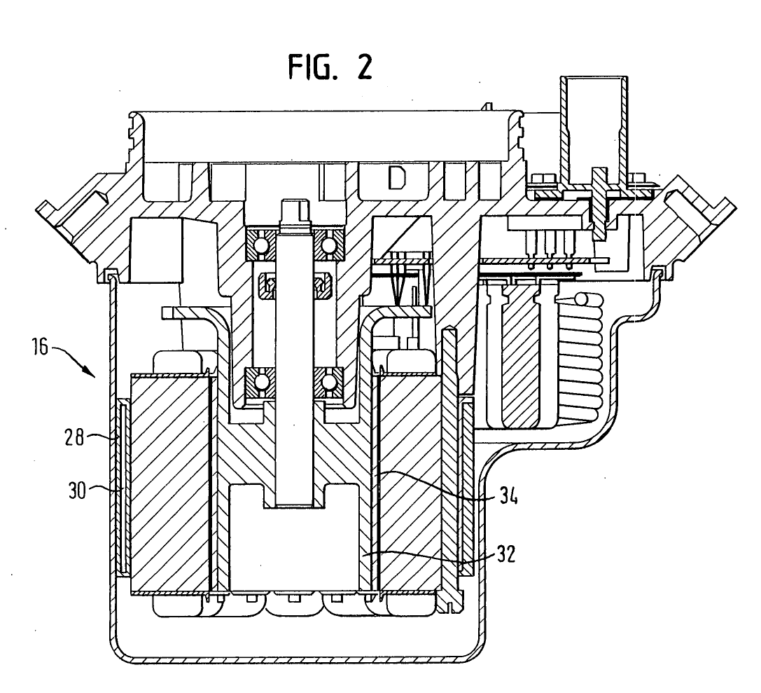

FIG. 2 shows a detail view of an electromotor 16 that can be used in a hydraulic system according to the present invention. Electromotor 16 is an internal-rotor motor having a rotor 32 and a stator 34. Arranged around stator 34 is a cooling jacket 28, made of a heat-conductive material, so that a cooling chamber 30 is formed between cooling jacket 28 and stator 34. Fluid from the fluid circulation system runs through cooling chamber 30, thus cooling electromotor 16.

Cooling chamber 30 of electromotor 16 can also be arranged in a pressure line of the fluid circulation system.

To increase the cooling output, the wall of cooling jacket 28 that is adjacent to stator 34 can be covered with a heat-conductive paste.

1. A hydraulic system for providing an auxiliary force for a motor vehicle device, said hydraulic system comprising a fluid circulation system, said fluid circulation system including a pump, an electromotor and a reservoir, said pump delivering fluid from said reservoir, said electromotor driving said pump, said fluid circulation system further including a cooling jacket for said electromotor, said cooling jacket defining a cooling chamber, fluid of said fluid circulation system flowing through said cooling chamber.

2. The device as recited in claim 1, wherein said cooling chamber is arranged in a return line of said fluid circulation system.

3. The device as recited in claim 1, wherein said cooling chamber is arranged in a pressure line of said fluid circulation system.

4. The device as recited in claim 1, wherein said electromotor is an internal-rotor motor.

5. The device as recited in claim 4, wherein said cooling jacket surrounds a stator of said electromotor.

6. The device as recited in claim 5, wherein said cooling jacket includes a wall adjacent to said stator, said wall being coated with a heat-conductive paste.
